(19) United States
(12) Patent Application Publication
(10) Pub. No.: US 2026/0278218 A1
(43) Pub. Date: Sep. 17, 2026

(54) PASSIVE STRUCTURE DESIGNS FOR PHASED ANTENNA ARRAYS

(71) Applicant: 3M INNOVATIVE PROPERTIES COMPANY, St. Paul, MN (US)

(72) Inventors: Zohaib Hameed, Woodbury, MN (US); Milo G. Oien-Rochat, Minneapolis, MN (US); Jaewon Kim, Woodbury, MN (US); Elias Wilken-Resman, Minneapolis, MN (US); Nader Tavaft, Minneapolis, MN (US); lan Cummings, Brookfield, MN (US); Jennifer J. Sokol, Mahtomedi, MN (US); Charles L. Bruzzone, Woodbury, MN (US); Lars Schrix, Duisburg (DE); Christian Weinmann, Alsdorf (DE); Jeffrey A. Tostenrude, Leander, TX (US); Marcus Schwarting, Boilingbrook, IL (US); Karthik Subramanian, St. Paul, MN (US); Jeffrey D. Keeney, Hudson, WI (US); Yehuda E. Altabet, Sharon, MA (US)

(21) Appl. No.: 19/470,398

(22) PCT Filed: Mar. 15, 2024
(86) PCT No.: PCT/IB2024/052535

§ 371 Date: Sep. 29, 2025

Related U.S. Application Data
(60) Provisional application No. 63/492,997, filed on Mar. 29, 2023.

(51) Int. Cl. G06F 30/27; G06F 111/06

(52) U.S. Cl. CPC G06F 30/27; G06F 2111/06

(57) ABSTRACT

Systems and techniques for generating passive structure designs are disclosed. Passive structures constructed according to the generated designs improve performance of phased antenna arrays into which the passive structures are incorporated. A device includes a non-transitory computer-readable storage medium encoded with instructions, and processor(s) coupled to the non-transitory computer-readable storage medium. The processor(s) are configured to execute the instructions to receive a passive structure design, to generate a figure of merit based on the passive structure design and frequency data using a simulation technique, to generate a pool of samples, to select a final sample from the pool of samples using an acquisition function, to provide the final sample to the simulation technique to generate a figure of merit, the final sample being associated with a new passive structure, and to output the new passive structure.

### TECHNICAL FIELD

This disclosure relates to systems and techniques for designing passive structures to be used in phased antenna arrays.

### SUMMARY

As part of upgrading the current mobile network infrastructure to provide 5G voice and data services, millimeter wave (mmWave) phased-array antennas are being installed on the existing radio access network (RAN) cell sites. As used herein, 5G refers to voice and data services that comply with the fifth-generation technology standard for broadband cellular networks. Each such site typically supports three sector antenna arrays, with each antenna array providing 120° (i.e. +/−) 60° azimuthal coverage within a given cell. Combined, the three sector antennas provide 360° omnidirectional coverage around the site. Prevalent 4G/LTE systems work on frequencies below 6 GHz, which have low propagation losses in comparison to mmWave frequencies, which are generally at or above 20 GHz. To provide the network coverage at the same range (distance from the RAN cell site) as prevalent 4G/LTE systems, mmWave antennas must (i) be highly directive, and (ii) have steerable radiation patterns. Antenna arrays, which include multiple radiating elements provide these enhancements in the context of mm Wave equipment. Antenna arrays generally provide spatial diversity (a facet by which a base station can communicate with multiple devices within the same cell using the same time-frequency resource with the help of highly directive antennas) using massive multiple-input, multiple-output (massive-MIMO) architectures as in the case of 5G system specifications.

High directivity, however, introduces one or more diminishments. Providing high directivity requires many elements in each phased array, and limits the azimuthal scan range of the overall antenna system due to beam broadening as the phased array broadcasts further from the optical axis referred to as “antenna boresight.” As such, mmWave phased arrays, being highly directional, cannot provide 120° coverage without introducing significant gain degradation at wider scan angles. This gain degradation leads to decreased coverage at the sector seams within a communication cell.

Techniques of this disclosure are directed to designing passive structures (e.g., dielectric lenses) that broaden the scan range of mm Wave phased antenna arrays. A potential advantage provided by the passive structure designs (e.g. dielectric lens designs) of this disclosure relates to obtaining a narrower beamwidth. For example, a lower order array (e.g., an array with a lesser number of antenna elements) incorporating the passive structure designs of this disclosure can provide resolutions similar to a higher order array (e.g., an array with a greater number of antenna elements).

In one example, a passive structure generation device includes at least one non-transitory computer-readable storage medium and one processor coupled to the at least one non-transitory computer-readable storage medium. The at least one non-transitory computer-readable storage medium has instructions stored thereon. The at least one processor is configured to execute the instructions to receive a passive structure design, to generate a figure of merit based on the passive structure design and frequency data using a simulation technique, to generate a pool of samples, to select a final sample from the pool of samples using an acquisition function, to provide the final sample to the simulation technique to generate a figure of merit, the final sample being associated with a new passive structure, and to output the new passive structure to at least one of a user interface, an external device, or the at least one non-transitory computer-readable storage medium.

In another example, a device includes interface hardware, memory hardware, and processing circuitry communicatively coupled to the memory hardware. The interface hardware is configured to receive a passive structure design. The memory hardware is configured to store the passive structure design received via the interface hardware. The processing circuitry is configured to generate a figure of merit based on the passive structure design stored to the memory hardware and frequency data using a simulation technique, to generate a pool of samples, to select a final sample from the pool of samples using an acquisition function, to provide the final sample to the simulation technique to generate a figure of merit, the final sample being associated with a new passive structure, and to output the new passive structure to at least one of a user interface, an external device, or the at least one non-transitory computer-readable storage medium. The processing circuitry is configured to perform at least one of outputting the new passive structure design via the interface hardware, and/or to store the new passive structure design to the memory hardware.

In another example, a method includes receiving, by processing circuitry of a computing device, a passive structure design, generating, by the processing circuitry, a figure of merit based on the passive structure design and frequency data using a simulation technique, generating, by the processing circuitry, a pool of samples, selecting, by the processing circuitry, a final sample from the pool of samples using an acquisition function, providing, by the processing circuitry, the final sample to the simulation technique to generate a figure of merit, the final sample being associated with a new passive structure, and outputting, by the processing circuitry, the new passive structure to at least one of a user interface, an external device, or at least one non-transitory computer-readable storage medium.

In another example, an apparatus includes means for receiving a passive structure design, means for generating a figure of merit based on the passive structure design and frequency data using a simulation technique, means for generating a pool of samples, means for selecting a final sample from the pool of samples using an acquisition function, means for providing the final sample to the simulation technique to generate a figure of merit, the final sample being associated with a new passive structure, and means for outputting the new passive structure to at least one of a user interface, an external device, or at least one non-transitory computer-readable storage medium.

In another example, a non-transitory computer-readable storage medium is encoded with instructions. The instructions, when executed by processing circuitry of a computing device, cause the processing circuitry to receive a passive structure design, to generate a figure of merit based on the passive structure design and frequency data using a simulation technique, to generate a pool of samples, to select a final sample from the pool of samples using an acquisition function, to provide the final sample to the simulation technique to generate a figure of merit, the final sample being associated with a new passive structure, and to output the new passive structure to at least one of a user interface, an external device, or the at least one non-transitory computer-readable storage medium.

The passive structure design techniques of this disclosure provide several technical improvements in the technical field of phased antenna array design. In this way, the passive structure designs of this disclosure may reduce the design complexity and cost of the phased antenna array systems by reducing the number of one or more of phase-shifters, amplifiers, and/or impedance-matching networks required in the system. Passive structures designed according to the techniques of this disclosure provide these performance enhancements in the context of three-sector antenna implementations, but in many cases, can reduce the infrastructure to one-antenna or two-antenna arrays, particularly in use cases that cover a smaller, more densely device-deployed area, such as an urban downtown area. Moreover, the improvements provided by passive structures designed according to the techniques of this disclosure improve performance and capacity at the cell level, thereby potentially reducing the number of arrays required from a higher (e.g., system-level) perspective.

### BRIEF DESCRIPTION OF DRAWINGS

FIGS. 1A & 1B illustrate differences between the signal coverage provided by an existing phased antenna array and the enhanced signal coverage of a corresponding phased antenna array that is equipped with passive structures designed according to the techniques of this disclosure.

FIG. 2 is a block diagram illustrating an example implementation of a passive structure generation device of this disclosure.

FIG. 3 is a flowchart illustrating an example workflow of this disclosure.

FIG. 4 is a flowchart illustrating an example process that the passive structure generation device of FIG. 2 may implement to perform Bayesian optimization techniques of this disclosure.

FIG. 5 is a graph illustrating a clustering of a sample set within constraints imposed according to the techniques of this disclosure.

FIG. 6A is a graph that shows the convergence of figure of merit (FoM) across a number of runs of an electromagnetic simulator (EM) for an expected improvement (EI) function that is at the explorative end of the acquisition function spectrum.

FIG. 6B is a graph showing width and pitch distributions for the EI acquisition function associated with FIG. 6A.

FIG. 7 is a graph that shows FoM convergence across a number of runs of the EM simulator.

FIG. 8 is a graph that shows FoM convergence across a number of runs of the EM simulator.

FIGS. 9A & 9B illustrate various dielectric lens shapes generated by the passive structure generation device of FIG. 2 in accordance with the Bayesian-optimized design techniques of this disclosure.

FIG. 10 is a graph that shows one of the performance metrics (namely, the peak gain) of various phased antenna arrays at various scan angles.

FIG. 11 illustrates aspects of various examples of optimized passive structure designs of this disclosure in comparison to a conventional passive structure design.

FIG. 12 is a data flow diagram (DFD) that illustrates an example data flow in accordance with the techniques of this disclosure.

### DETAILED DESCRIPTION

Systems of this disclosure address various performance pitfalls of existing 4G/LTE antenna arrays when repurposed for 5G voice and data service delivery. Passive structures (e.g., dielectric lenses) designed according to the techniques of this disclosure, when incorporated into phased antenna arrays, improve signal coverage. For example, the passive structures designed according to the techniques described herein may enable the phased antenna arrays to maintain a non-increasing beamwidth even as the azimuthal angle increases.

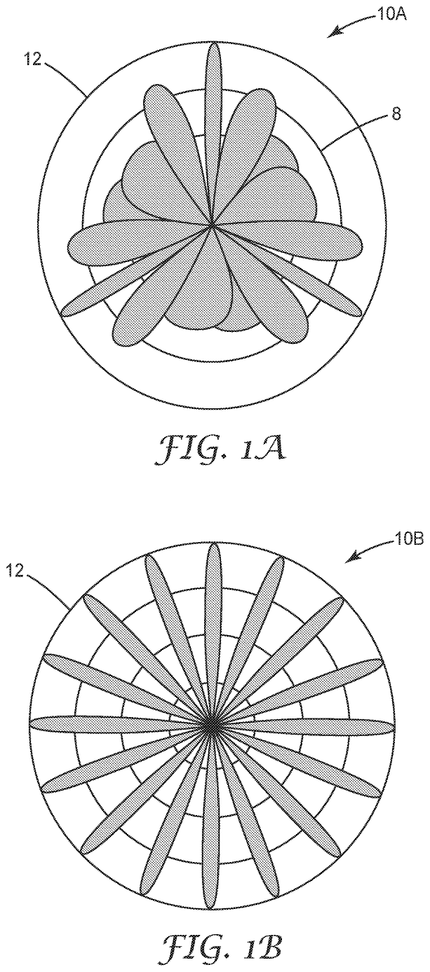

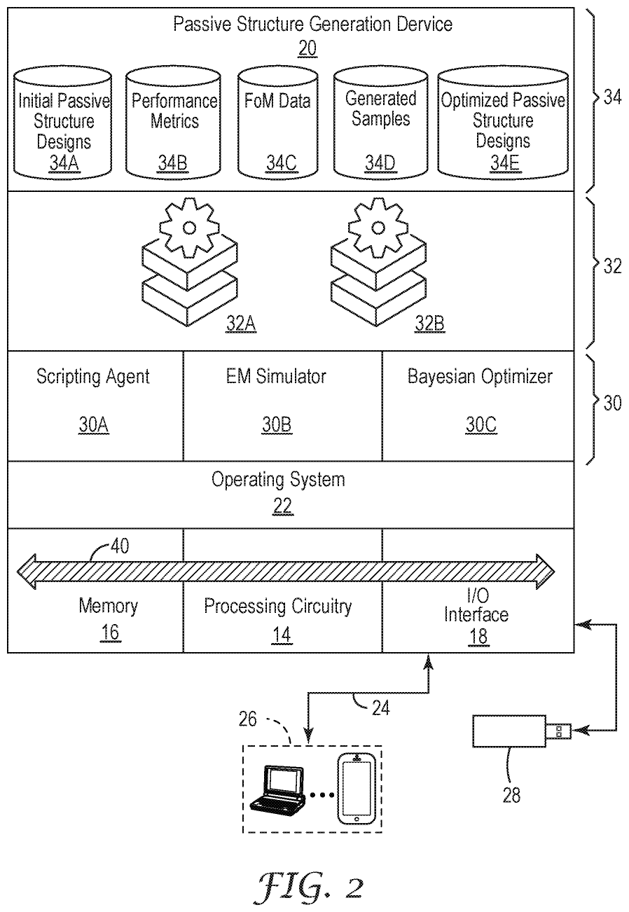

FIGS. 1A & 1B illustrate differences between the signal coverage provided by an existing phased antenna array and the enhanced signal coverage of a corresponding phased antenna array that is equipped with passive structures designed according to the techniques of this disclosure. FIG. 1A illustrates signal coverage provided by a three-sector antenna array that is equipped with currently available passive structures (e.g., dielectric lenses). System 10A of FIG. 1A provides three instances of radio frequency (RF) beams at boresight angles (i.e. zero degrees from the respective antenna of the three-sector array), equally spaced at 120 degrees from one another, that reach cellular boundary 12. FIG. 1A illustrates signal blind zone 14, which is a non-limiting example of signal coverage gaps (or so-called “dead spots”). While system 10A includes two other of signal coverage gap in addition to signal blind zone 14. The radio frequency (RF) beams in these areas of signal coverage gap exhibit widened beamwidth in proportion to the corresponding azimuthal angles. The wider beamwidths associated with these RF beams diminishes the corresponding beam depths, thereby causing signal coverage diminishments or dead zones before reaching the perimeter represented by cellular boundary 12.

FIG. 1B illustrates signal coverage provided by a three-sector antenna array that is equipped with passive structures (e.g., dielectric lenses) that are designed according to the techniques of this disclosure. All sixteen RF beams of system 10B of FIG. 1B reach cellular boundary 12, because the beamwidths of the beams do not increase with the azimuthal angle and the gain is uniform with the azimuthal angle. The radiation patterns of the boresights provide signal coverage throughout the 360-degree sweep of system 10B, as shown by way of the non-limiting example of signal coverage zones 16.

As shown by way of the example of FIG. 1B, passive structures (e.g., dielectric lenses) designed according to the techniques of this disclosure enable full-cell site signal coverage, even when retrofitted into existing three-sector antenna array infrastructures. The full-cell signal coverage provided by system 10B is realized through passive structures that are designed using automated design techniques of this disclosure. In some examples, the performance of passive structures that are designed according to the techniques of this disclosure may be validated via field testing via integration into a phased antenna array. In other examples, the performance of passive structures that are designed according to the techniques of this disclosure may be validated via simulation-based techniques, such as by modeling the performance of the designs using a simulation tool.

An example workflow according to the simulation-based validation techniques of this disclosure is described below. Systems of this disclosure may execute a scripting agent to generate logical representations of various lens shapes. A simulation tool (e.g., an electromagnetic solver environment) run by the systems of this disclosure may ingest one or more files (e.g., one or more .stl files) for performance modeling purposes. In one non-limiting example, the simulation tool may ingest a single .stl file per simulation pass.

The simulation tool may execute an automated electromagnetic (EM) modeling run, under a simulation configuration in which the designed passive structure is placed on the phased antenna array. The systems of this disclosure may collect the performance data modeled for each ingested passive structure design in a structured format. The systems of this disclosure may generate a figure of merit (FoM) value for a given passive structure design based on the respective performance metric(s) modeled by the simulation tool for the phased antenna array into which the passive structure design is integrated.

Based on the FoM assigned to the passive structure design that is evaluated in the current pass and (if available), FoM results from previous runs, the systems of this disclosure may select the next sample (passive structure design) for which to run a simulation, and may iterate the workflow described above. By iterating the above-described workflow for multiple passive structure designs, the systems of this disclosure may generate a dataset of actual modeling results for different lens shapes when integrated into a phased antenna array (such as a 5G antenna array).

To achieve the results described above in a computing resource-efficient way, the systems of this disclosure incorporate Bayesian optimization techniques. Bayesian optimization can be described as a global optimization technique that attempts to find the optimum value of a non-convex, potentially non-differentiable, expensive process within a constrained number of function evaluations (also referred to as a “limited budget”). In the context of the passive structure design generation techniques described herein, the systems of this disclosure leverage Bayesian optimization techniques to reduce the resource costs associated with the EM simulation runs. Rather than searching for the optimum passive structure design using a brute force search of the entire input space while running a simulation pass at each input point, the systems of this disclosure are configured to incorporate Bayesian optimization to reduce the number of simulation passes that are executed in order to obtain the optimum passive structure design.

FIG. 2 is a block diagram illustrating an example implementation of a passive structure generation device 20 of this disclosure. While FIG. 2 shows one implementation of passive structure generation device 20 that is consistent with aspects of this disclosure, it will be appreciated that other architectures (whether single-device architectures or distributed architectures) of the functionalities described with respect to passive structure generation device 20 are consistent with aspects of this disclosure, as well. Passive structure generation device 20 is described, as a non-limiting example, as performing functionalities of both a training system and a utilization system. In other examples consistent with this disclosure, systems may be configured to perform either exclusively as a training system, or exclusively as a utilization system. As such, it will be appreciated that different configurations are consistent with the techniques of this disclosure, and that FIG. 2 illustrates one non-limiting example of a system configuration consistent with this disclosure.

In the example of FIG. 2, passive structure generation device 20 includes processing circuitry 14 and memory 16. In some examples, processing circuitry 14 and memory 16 may be integrated into a single hardware unit, such as a system on a chip (SoC) or integrated circuit (IC). Processing circuitry 14 may represent one or more processors or processing units, each of which may comprise one or more of a multi-core processor, a controller, a digital signal processor (DSP), an application specific integrated circuit (ASIC), a field-programmable gate array (FPGA), processing circuitry (e.g., fixed function circuitry, programmable circuitry, or any combination of fixed function circuitry and programmable circuitry) or equivalent discrete logic circuitry or integrated logic circuitry. Memory 16 may include any form of memory for storing data and executable software instructions, such as random-access memory (RAM), read-only memory (ROM), programmable read only memory (PROM), erasable programmable read-only memory (EPROM), electronically erasable programmable read only memory (EEPROM), and flash memory. Memory 16 may include a single memory unit or multiple memory units in various implementations.

Memory 16 and processing circuitry 14, in combination, provide a computing platform for executing operating system 22. Operating system 22 provides a multitasking operating environment for executing one or more software components 30. As shown, processing circuitry 14 connects via an input/output (I/O) interface 18 to external systems and devices, e.g., via one or more communication networks. I/O interface 18 may incorporate network interface hardware, such as one or more wired and/or wireless network interface controllers (NICs) for communicating via communications link 24. In the particular example of FIG. 2, communications link 24 represents one or more network-enabled communicative connections, such as a link to one or more packet-switched networks collectively referred to in the context of FIG. 2 as a “communicative network.” The communicative network may represent any of a data-enabled telephony network (such as a cellular data network), a wide-area network (such as the Internet), a public network (such as the Internet), a private network such as a local-area network (LAN) and/or an enterprise network, or any other type of network that enables data communications, or any combination of any two or more of the networks listed above.

Communications link 24 communicatively couples passive structure generation device 20 to the communicative network, and via the communicative network, to other devices. Each of communications links 24 may include one or more wired connections (e.g., an Ethernet® connection), wireless connections (e.g., a Wi-Fi™ connection) or a combination of both wired and wireless communicative connections. In the example illustrated in FIG. 2, I/O interface 18 also facilitates communication between passive structure generation device 20 and one or more remote devices 26 via communications link 24. In the particular example of FIG. 2, communications link 24 represents one or more local connections, such as a connection to remote devices 26 via a local area network (LAN) and/or personal area network (PAN) connections, such as one or more of near-field communication (NFC) pairings, Bluetooth® pairings, Zigbee® pairings, or the like. Remote devices 26 may include any one or more of computing devices (e.g., devices deployed at dielectric lens manufacturing entities), additive manufacturing devices (e.g., so-called “3D printers”), or the like.

Bus 36 provides inter-component connectivity between processing circuitry 14, memory 16, and I/O interface 18 in the implementation shown in FIG. 2. Bus 36 may represent a half-duplex or full-duplex bus that provides data transfer capabilities between two or more of processing circuitry 14, memory 16, I/O interface 18, and/or any other hardware components of passive structure generation device 20. Bus 36 may represent a system bus or a computer bus of various types, including one or more bus networks. Regardless of the topology implemented, bus 36 may, in various examples, incorporate various types of inter-component connectivity hardware such as those conforming to any of first generation, second generation, third generation, or fourth generation bus or bus network technology as set forth by the Institute of Electrical and Electronics Engineers (IEEE), and/or other bus or bus network technologies defined in developing or later-adopted standards.

Software components 30 of passive structure generation device 20, in the particular example of FIG. 2, include scripting agent 30A, electromagnetic (EM) simulator 30B, and Bayesian optimizer 30C. In some example approaches, one or more of software components 30 represent executable software instructions that may take the form of one or more software applications, software packages, software libraries, hardware drivers, and/or Application Program Interfaces (APIs). Moreover, any of software components 30 may, when executed, cause passive structure generation device 20 to output data and/or receive data via I/O interface 18.

Aspects of memory 16 that provide non-volatile storage and/or long-term storage support the local storage of data repositories 34 at passive structure generation device 20. In the example of FIG. 2, data repositories 34 include initial passive structure designs 34A, performance metrics 34B, figure of merit (FoM) data 34C, generated samples 34D, and optimized passive structure designs 34E. In some examples, software components 30 may implement read/write capabilities with respect to data repositories 34, such as to access and use information available from data repositories 34 and/or to modify information currently stored to data repositories 34. In implementations in which passive structure generation device 20 represents a distributed computing system, one or more of data repositories 34 may be partially or entirely positioned at a remote location from processing circuitry 14, and software components 30 may, in these implementations, access data repositories 34 using NIC hardware of I/O interface 18.

One or more of software components 30 may invoke processing circuitry 14 and memory 16 to access one or more of data repositories 34 to retrieve data for various purposes, such as for passive structure design generation, optimization of the design generation process, etc. Passive structure generation device 20 may train training model 32A and/or execute trained model 32B of AI/ML models 32 in accordance with aspects of this disclosure, as described in greater detail below.

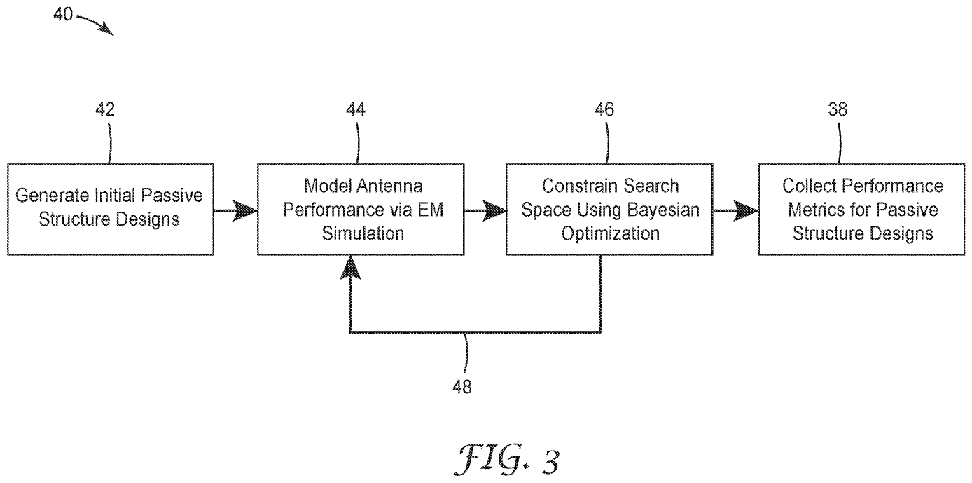

FIG. 3 is a flowchart illustrating an example workflow 40 of this disclosure. To begin an iteration of workflow 40, scripting agent 30A may run a scripting agent to generate initial passive structure designs 32A (42). Initial passive structure designs 32A include logical representations of various dielectric lens shapes and/or form factors. In a given iteration of workflow 40, EM simulator 32B may model the performance of a phased antenna array that is augmented with a respective lens that is designed according to one of initial passive structure designs 32A (44).

In one non-limiting example, EM simulator 30B may ingest a single .stl file that includes the input data used for the current simulation pass. As an output of the EM simulation run, EM simulator 32B may generate a figure of merit (FoM) value for the respective initial passive structure design 34A and store the generated FoM value to FoM data 34C. Based on the FoM value stored to FoM data 34C for the most recent run of EM simulator 30B, acquisition function 58 is leveraged to select a new design from within the search space, as part of the Bayesian process 30C, for enhanced dielectric lens designs (46).

The Bayesian optimization techniques implemented by Bayesian optimizer 30C can be described as a global optimization technique that attempts to find the optimum value of a non-convex, potentially non-differentiable, expensive process within a constrained number of function evaluations (also referred to as a “limited budget”). In the context of the passive structure design generation techniques described herein, Bayesian optimizer 30C implements these techniques to reduce the resource costs associated with potentially numerous execution iterations of EM simulator 30B. Rather than causing passive structure generation device 20 to search for an optimum dielectric lens shape using a brute force search of the entire input space (and thereby requiring a run of EM simulator 30B for each input point of the input space), Bayesian optimizer 30C reduces the number of runs of EM simulator 30B that are executed in order to obtain the optimum passive structure design.

Based on the recommendations obtained at 46, Bayesian optimizer 30C may provide an updated passive structure design to EM simulator 30B (feedback loop 48). By iterating Bayesian optimizer 30C runs at 46 and feedback loop 48, passive structure generation device 20 reduces the number of runs of EM simulator 30B, while maintaining the relevance of the dielectric lens designs that are modeled by way of these reduced runs of EM simulator 30B. Bayesian optimizer 30C also stores the optimized dielectric lens shape information to optimized passive structure designs 34E (38).

Non-limiting examples of performance metrics 34B include values such as gain, beam width (which may, in some instances be specified as a “half power beam width”), a maximum gain (which is an indicator of beam depth), etc. In various use-case scenarios consistent with aspects of this disclosure, each data point included in performance metrics 34B may be matched to a particular scan angle for which EM simulator 30B generated the respective performance metric of performance metrics 34B.

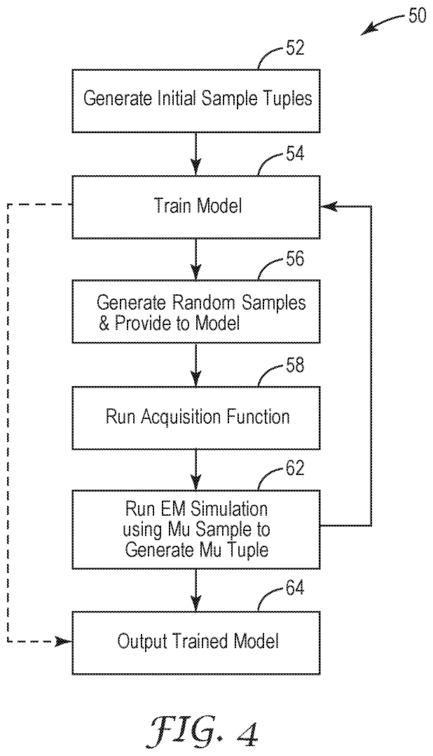

FIG. 4 is a flowchart illustrating an example process 50 that passive structure generation device 20 may implement to perform Bayesian optimization techniques of this disclosure. Process 50 may begin with scripting agent 30A running a script to generate a set of initial sample tuples (52). The structure of the tuple may include a description of one of initial passive structure designs 34A combined with an FoM value (e.g., as stored to FoM data 34C) generated based on a simulation run of EM simulator 30B. Passive structure generation device 20 includes AI/ML models 32. AI/ML models include training model 32A. Bayesian optimizer 30C may use Gaussian regression to fit training model 32A using the tuples representing the current run's initial passive structure designs 34A as independent variables and their corresponding FoM values of FOM data 34B as dependent variables. More specifically, Bayesian optimizer 30C may train training model 32A using this Gaussian regression technique (54). A single pass of the training process for training model 32A is represented at 54.

Bayesian optimizer 30C may generate random sample parameter value sets and provide the random sample parameter sets to training model 32A (56). Bayesian Optimizer 30C may also run an optimization over training model 32A to obtain a set of optimized samples. For instance, Bayesian optimizer 30C may generate various dielectric lens shapes based on the initial sample tuple evaluated in the current iteration of process 50, and store representations of one or more of these generated shapes to generated samples 34D. In turn, Bayesian optimizer 30C may assess the generated sample(s) stored to generated samples 34D in the most recent iteration of process 50 by running an acquisition function (58). By running the acquisition function at 58 for the selected sample(s) of generated samples 34D, Bayesian optimizer 30C produces predicted FoM values for each respective set of generated samples 34D.

The acquisition function orders the value sets by weighting based on both their likelihood to produce a higher FoM value and uncertainty of training model 32A with respect to each sample's corresponding FoM value. Bayesian optimizer 30C selects the highest-weighted point or points, thereby selecting the next sample to be evaluated. Because further evaluation may represent a computationally intensive operation, Bayesian optimizer 30C conserves computing resource usage by selecting a sample out of the set represented by generated samples 34D that is expected to both have a desired performance and improve the performance of training model 32A.

EM simulator 30B ingests the one(s) of generated samples 34D that are selected by the acquisition function. In some instances, one or more of generated samples 34D may represent random samples or randomly generated samples. Each run of EM simulator 30B represents an objective function. EM simulator 30B assesses the search-constrained samples of generated samples 34D using the objective function, returning simulation results in the form of an FoM value. If the search-constrained sample is identified by the symbol u, EM simulator 30B runs an EM simulation using the u sample to generate a u tuple (62). The u tuple includes the lens design represented by the u sample and the FoM generated by EM simulator 30B in evaluating antenna performance for a phased antenna array that is augmented using the u sample. In turn, passive structure generation device 20 may provide the u tuple to training model 32A as training data for a subsequent training pass (or a retraining pass), thereby returning to 54.

Passive structure generation device 20 may iterate 54 through 62 to further retrain training model 32A. In some examples, passive structure generation device 20 may store the u tuples to one or more of data repositories 34. With respect to the initial sample tuples as well as the u tuples, Bayesian optimizer 30C may first normalize all values before running the values through Gaussian regression, but may store the original values to data repositories 34. Normalization ranges in accordance with the Gaussian regression described above include a range of zero to one and/or a range of negative one to one, among other possible ranges. After a number or training and retraining iterations, Bayesian optimizer 30C may determine that either the desired performance of one of the designs has been achieved or the optimization has run for a set amount of iterations. Passive structure generation device 20 may output trained model 32B (64).

In some examples, passive structure generation device 20 may invoke I/O interface 18 to deploy trained model 32B to external devices, such as by signaling trained model 32B to remote devices 26 over communications link 24. In some examples, deployment unit 30C may invoke I/O interface 18 to save a copy of trained model 32B to removable storage device 28. Removable storage device 28 may represent any type of non-volatile storage media, such as an external hard drive or solid-state drive (SSD), a USB flash drive, a CD, or the like. In these examples, passive structure generation device 20 enables other devices to run trained model 32B in an execution phase to generate passive structure designs according to the Bayesian-optimized techniques of this disclosure.

In some examples, passive structure generation device 20 may run trained model 32B in its execution phase to generate optimized passive structure designs 34E while leveraging the computational resource-conserving Bayesian-optimized techniques of this disclosure. In some examples, one or more samples of optimized passive structure designs 34E are provided as training data to train other models. Using one or more of optimized passive structure designs 34E to train other models provides the technical advantage of data precision with respect to the performance of models that are suited to be used as applications outside of Bayesian techniques, as well as the technical advantage of resource conservation in terms of training these other models more efficiently with a smaller (more optimized) set of training samples.

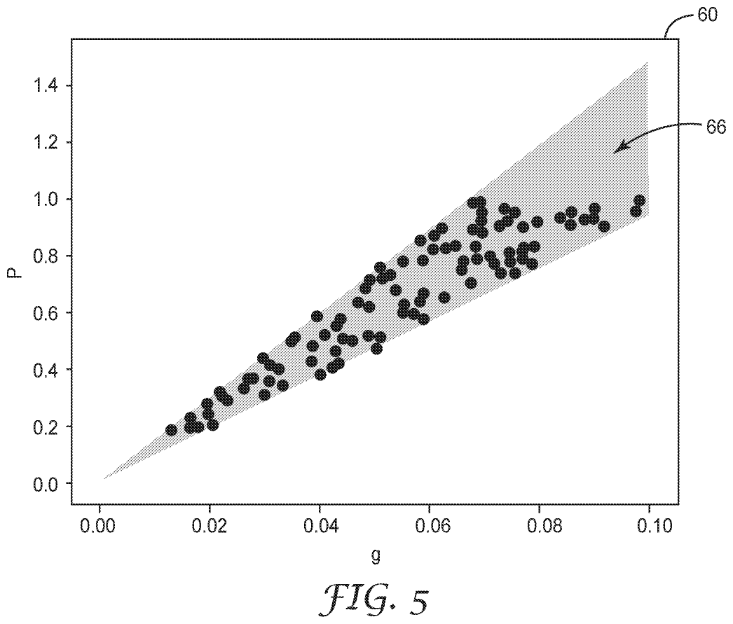

FIG. 5 is a graph 60 illustrating the clustering of a sample set within constraints imposed according to the techniques of this disclosure. The initial development of the platforms described herein incorporated the use of various initial data sets. In terms of dimensional definitions, pitches and widths of the ground planes and the signal plane were set to be the same. As used herein, “pitch” refers to a distance between the start of one thread and the next thread in a grid, while “width” refers to a linear measurement across a metallic trace, measured in a similar way to measuring the gauge of a wire. As used herein, “S11” refers to a signal traveling down the coplanar waveguide or ‘CPW’ (reflection coefficient, indicating how much power is reflected at the port), and “S21” refers to the reflected signal in the CPW (transmission coefficient, indicating how much power is lost in transmission).

In terms of the sampling shown in graph 60, dimensions were constrained by two boundary conditions and a set of ranges for each dimension. The samples were artificially and randomly distributed widely amongst the domain space. The space was split into sections along the independent variable dimension, and then randomized across the area designated by the sectioning. In other examples consistent with this disclosure, sampling may be conducted in a similar fashion while adding further dimensions by adding additional associated boundary conditions. Clustering 66 of FIG. 5 shows the pitch and width distribution, limited by transparency values. A minimum transparency of the CPW was established, defined as a percentage of empty space in the conductive mesh as shown in equation (1) below:

$$\frac{{( P - w )}^{2}}{{P}^{2}} \qquad ( 1 )$$

With respect to the connectivity of EM simulator 30B, the dimensions were used to change settings/run configurations to then programmatically build and executed a model. The results are exported then referenced by Bayesian optimizer 30C in the optimization process. The objective function represented by the simulation run by EM simulator 30B leverages the model to calculate values, and imports S11 and S21 parameters to achieve ‘actual’ values. As such, Bayesian optimizer 30C is configured to optimize the objective function according to the techniques of this disclosure.

Aspects of the definition of an individual FOM of FOM data 34C are described herein. The FoM value centers around the S11 and S21 parameters. EM simulator 30B may combine the S11 and S21 parameter values in a function. A number of different versions of this function are consistent with the aspects of EM simulator 30B and its functionalities as described herein. In some examples, EM simulator 30B may minimize the magnitude of the S11 parameter and maximize the value of the S21 parameter within the FoM. In one example embodiment of the function, if the average of the S11 parameter magnitudes across all frequencies (denoted as “|S11|avg”) was above a set minimum (denoted as “S11 min”) then the average of the S21 parameter magnitudes across all frequencies (denoted as “|S21|avg”) is used as the FoM determination. In an example of a final function for the FoM, EM simulator 30B excludes outliers by checking that the S11 magnitudes for each frequency are greater than S11 min and that the S21 magnitudes for each frequency are above a set S21 minimum (denoted as “S21 min”). Otherwise EM simulator 30B takes them as their respective minimum values. Table 1 and Table 2 below illustrate aspects of the FoM determination functions described above.

TABLE 1

| \|S11\|_{avg} − S11ₘᵢₙ | S11 |
|---|---|
| ≥0: | 0 |
| <0: | \|S11\|_{avg} − S11ₘᵢₙ |

TABLE 2

| S21min | S21 |
|---|---|
| ≥\|S21\|_{avg:} | \|S21\|_{avg} |
| <\|S21\|_{avg:} | S21ₘᵢₙ |

EM simulator 30B may average and combine the above-listed values according to equation (2) below:

$$β * \vert S 21 \vert avg - α * \vert S 11 \vert avg \qquad ( 2 )$$

With respect to the acquisition function referred to in FIG. 5, a number of different acquisition functions were evaluated. There is a trade off in using the different functions. The Upper Confidence Bound (UCB) function shown below embodies more of an exploitation prerogative and maximizes reward in the short term in a localized area to the current best position in the domain. The Expected Improvement (EI) function shown below sacrifices short-term reward for the potential of a better long-term reward by further exploring a wider area of the domain and leveraging the knowledge gain. The Probability of Improvement function shown below is somewhere between the exploitative nature of UCB and the explorative nature of EI.

```
  Probability of Improvement:
x = argmax [symbol] E(u(x)|D), u(x) = 0, 1 for f < f [symbol] , f ≥ f⁺
PI(x) = P(f(x) ≥ μ⁺ + ζ) ⇒ PI(x) = Φ(Z),
Z = (μ(x) − μ⁺ − ζ)/σ(x)
where μ⁺ isf the max mean, ζ = 1e−9, Φ is the Gaussian CDF and φ
is the Gaussian PDF.
Note f(x) is approximated by a surrogate Gaussian Process which
returns μ [symbol] σ for various x.
  Expected Improvement:
x = argmax [symbol] E( [symbol] (x)|D), u(x) = 0, f − f [symbol] for f < F [symbol] , f ≥ f [symbol]
EI(x) = (μ(x) − μ [symbol] − [symbol] Φ(Z) + σ(x)φ(Z) if σ(x) > 0
EI(x) = 0 if σ(x) = 0
  Upper Confidence Bound:
UCB(x) = μ(x) + βσ(x) with β > 0 for maximization problem. [symbol]
indicates data missing or illegible when filed
```

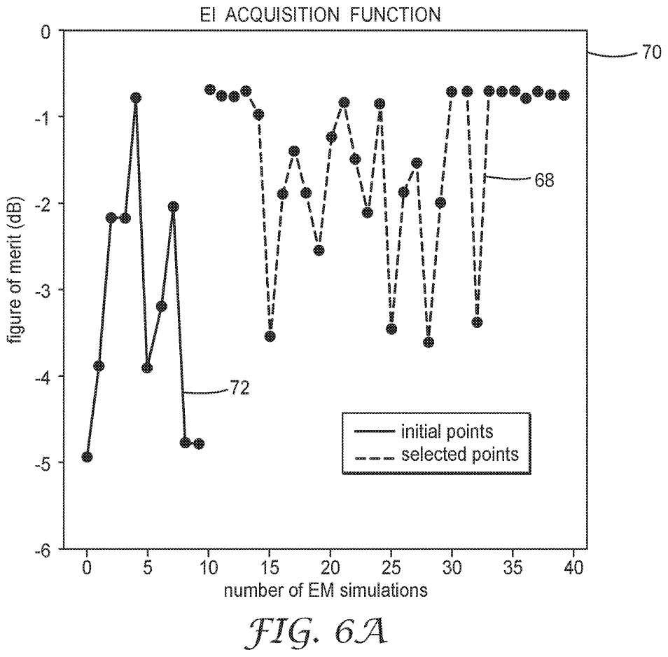

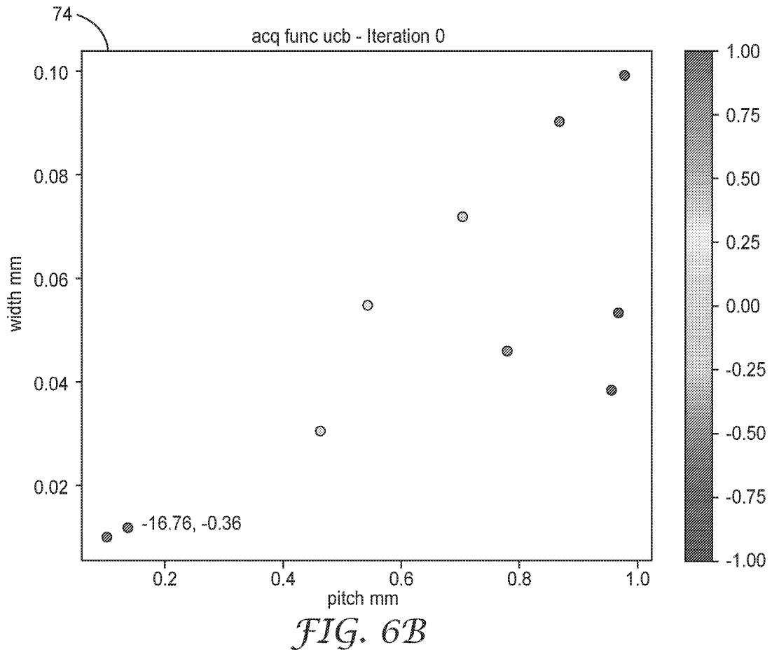

FIG. 6A is a graph 70 that shows the convergence of the FoM across a number of runs of EM simulator 30B for an EI function that is at the explorative end of the acquisition function spectrum. Plotline 72 shows the FoM data for the initial points while plotline 68 shows the eventual convergence of the portion of FOM data 34C that is applicable to the selected points represented by simulations run using phased antenna arrays augmented with one of optimized passive structure designs 34E.

FIG. 6B is a graph 74 showing width and pitch distributions for the EI acquisition function associated with FIG. 6A.

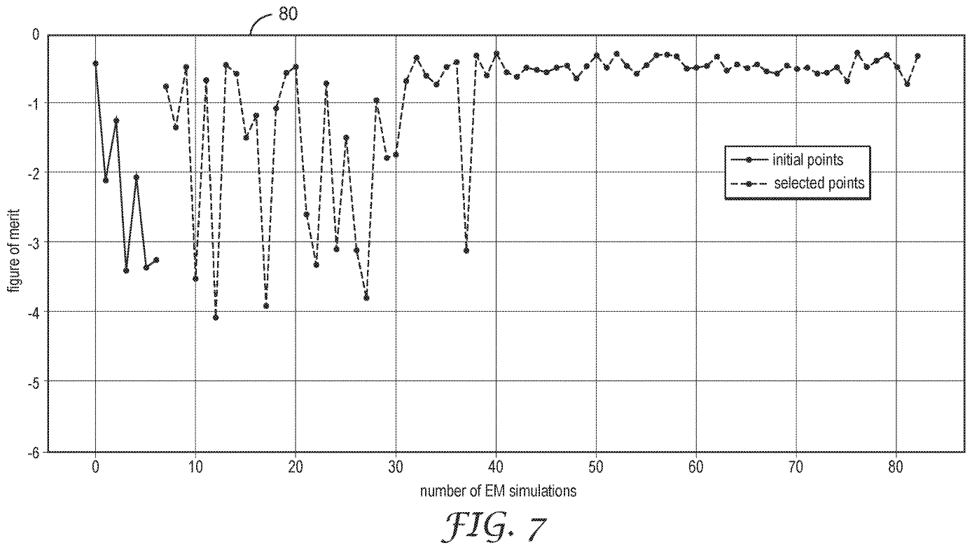

FIG. 7 is a graph 80 that shows FoM convergence across a number of runs of EM simulator 30B. The particular use-case scenario of graph 80 shows a decisive convergence (or stabilization) of the FoM within at just under 40 iterations and remaining in place until about 80 iterations of execution runs of EM simulator 30B. The plotline for “initial points” refers to the FoM data 34C that EM simulator 30B calculates for the initial sample tuples described above with respect to FIG. 4, while the plotline for “selected points” refers to the FoM data 34C that EM simulator 30B calculates for the u tuples based on the search space constraints imposed by Bayesian optimizer 30C.

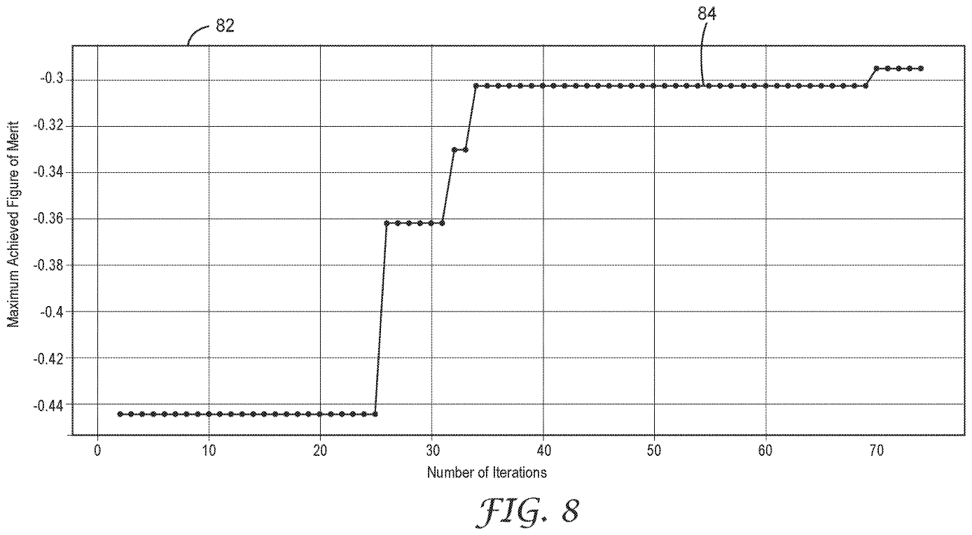

FIG. 8 is a graph 82 that shows FoM convergence across a number of runs of EM simulator 30B. As shown by way of FOM plotline 84 of FIG. 8, the maximum FoM stepped up multiple times as the optimization continued after approximately 25 iterations, and reached convergence (or a generally stable state) after approximately 33 iterations.

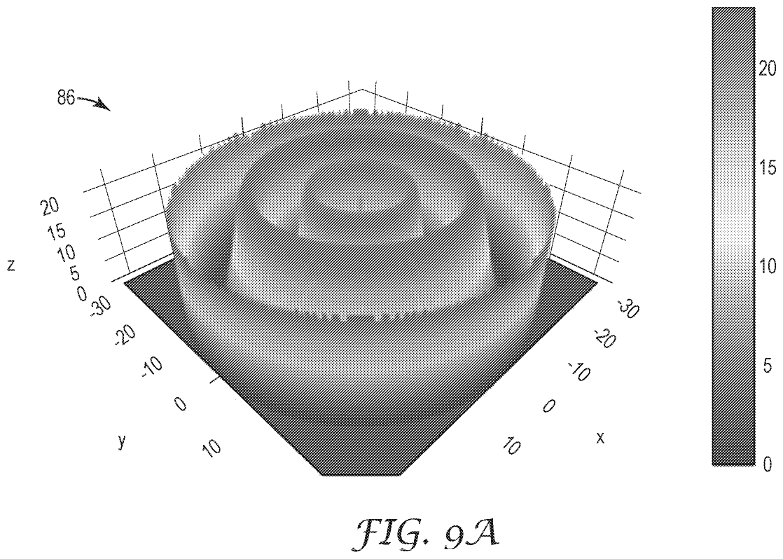

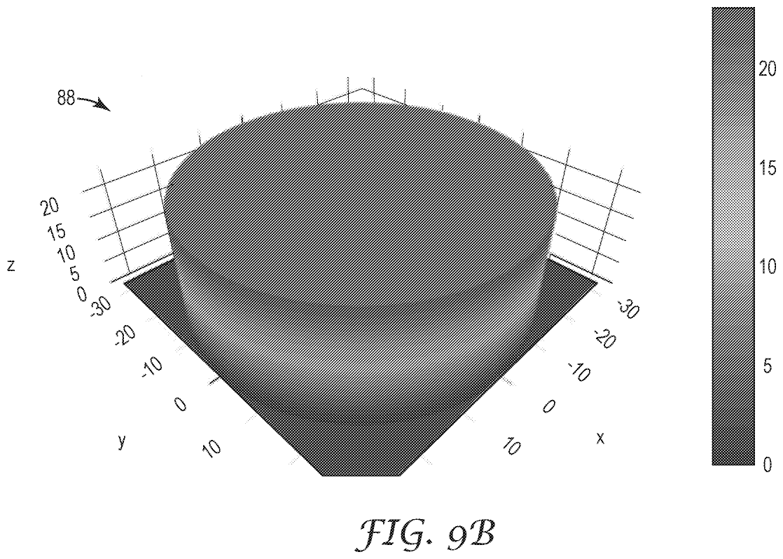

FIGS. 9A & 9B illustrate various dielectric lens shapes generated by passive structure generation device 20 in accordance with the Bayesian-optimized design techniques of this disclosure. Passive structure generation device 20 generates dielectric lens design 86 of FIG. 9A using the following polynomial coefficient set: (1,0, 1, 0, 1, 0.5, 0, 1). Passive structure generation device 20 generates dielectric lens design 88 of FIG. 9B using the following polynomial coefficient set: (1, 1, 1, 1, 1). With respect to both dielectric lens designs 86 and 88, passive structure generation device 20 may generate the dielectric lens shapes is generated using polynomials of an ‘n’ order coefficient which, as a representation, is 2D in nature, and rotating the polynomials by 360 degrees to generate a 3D shape. Passive structure generation device 20 generates both dielectric lens designs 86 and 88 using the solid-of-revolution technique described above.

An example calculation that EM simulator 30B may run to determine a given data point of FOM data 34C is shown in equation (3) below:

$$FoM = alpha * weighted\_average ( gain\_with \_lens - gain\_no \_lens ) + ( 1 - alpha ) * weighted\_average ( beamwidth\_no \_lens - beamwidth\_with \_lens ) - 0.5 * ( std ( gain\_with \_lens ) - std ( gain\_no \_lens ) ) \qquad ( 3 )$$

In some examples in accordance with the techniques of this disclosure, EM simulator 30B may set the constant alpha to a value of 0.7. As can be seen from equation (3), the FoM of a phased antenna array that is not augmented with any dielectric lens is zero (0). As such, any FoM value above zero (0) represents an improvement over an unaugmented phased antenna array. The weighting to the gain is based on the scan angles and whether the gain of the phased antenna array augmented with dielectric lens(es) is greater than the weighting to the gain for a phased antenna array that is not augmented with any lens. If the gain of the antenna with lens is less than that of the no-lens phased antenna array construction, it is penalized by a factor of five (5) irrespective of the scan angles. If the gain of the phased antenna array augmented with dielectric lens(es) is greater than that of a no-lens phased antenna array construction at smaller scan angles, the weighting factor is one (1). For larger scan angles in this scenario, this weighting factor is five (5).

Some additional modifications to the calculations described above in accordance with certain non-limiting examples of this disclosure include one or more of: (i) setting the gain to minimum_no_lens_gain at missing scan angles; (ii) setting the beamwidth to the average of beamwidths (for missing values); (iii) interpolating the with_lens case to have +2 deg resolution along the scan angle axis; and/or (iv) subtracting variance or std of gain from the FoM value.

As such, the FoM determinations described above can be summarized according to the following five precepts: (i) with lens augmentation, higher gain, lower beamwidth especially at large scan angles will lead to a greater FoM; (ii) any scan angle where the gain with lens augmentation becomes lesser than without lens augmentation, the FoM is heavily penalized (by a weighting factor of 5); (iii) if the gain of an antenna with lens augmentation is higher than without lens augmentation at all the scan angles, gain at larger scan angles is given more weightage than gain at smaller scan angles; (iv) the enhancement in gain with lens augmentation as compared to cases without lens augmentation is given more weightage than lowering of beamwidth when a lens is placed on an antenna array with the former being given 70% weightage and the latter being given 30%; and (v) the lesser the variation in the gain vis-à-vis scan angle curve, the greater the FoM will be. These aspects are shown by way of Table 3 below:

TABLE 3
(Option Z) Higher reward at higher scan angle − figure of merit

| | | | | | | | |
|---|---|---|---|---|---|---|---|
| If diff >0 | +1 | +1 | +1 | +1 | +1 | +5 | +5 |
| If diff <0 | −5 | −5 | −5 | −5 | −5 | −5 | −5 |
| Scan angle | 0 | 5 | 10 | 15 | 20 | 25 | 30 |

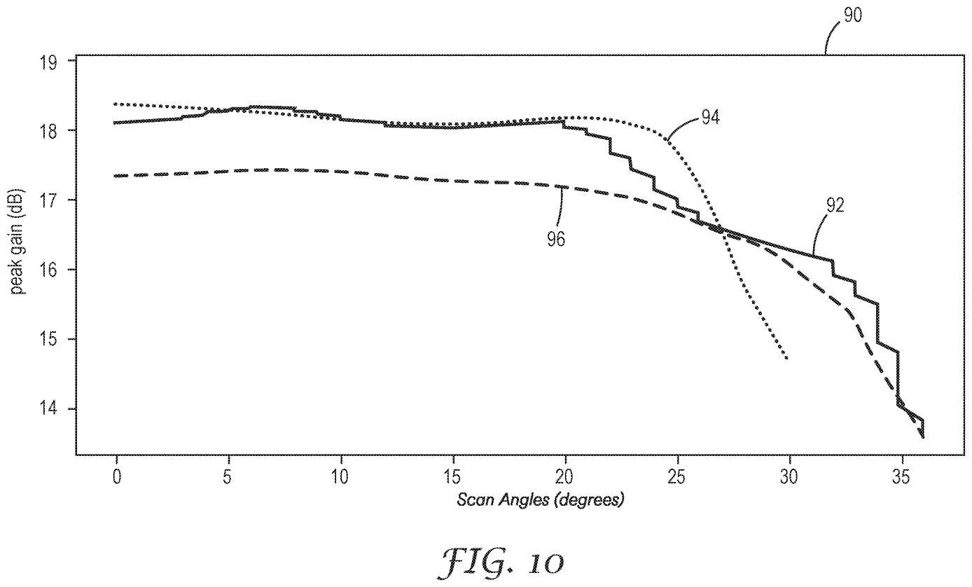

FIG. 10 is a graph 90 that shows one of performance metrics 34B (namely, the peak gain) of various phased antenna arrays at various scan angles. Control line 92 plots the peak gain of a phased antenna array without lens augmentation as the scan angle increases. Conventional lens line 94 plots the peak grain of a phased antenna array augmented with a conventional lens as the scan angle increases. Automated design line 96 plots the peak grain of a phased antenna array augmented with a dielectric lens designed by passive structure design device 20 using the techniques of this disclosure as the scan angle increases. Control line As shown by way of the comparison of automated design line 96 in comparison to conventional lens line 94 and control line 92, a phased antenna array augmented with a dielectric lens designed according to the Bayesian-optimized automated design techniques of this disclosure provides greater and more consistent improvements in terms of the peak gain (e.g., as expressed by way of beam-scan range) than the other scenarios. In this way, passive structure design device 20 implements the techniques of this disclosure to generate dielectric lens designs that improve performance metrics 34B (in this case, peak gain) while leverage Bayesian optimization to reduce the computational resource expenditure to generate the dielectric lens design. FoM data 34C reflects an FoM value of 1.03 for the dielectric lens associated with automated design line 96, while FoM data 34C reflects an FoM value of −8.49 for the conventional dielectric lens associated with conventional lens line 94.

FoM data 34C that EM simulator 30B generates based on phased antenna arrays augmented with one or more of optimized passive structure designs 34E show significant improvements in terms of other types of data stored to performance metrics 34B as well. For example phased antenna arrays augmented with the dielectric lens with the FoM value of 1.03 described above showed a significant reduction in beamwidth with widening scan angles as compared to phased antenna arrays that are left unaugmented and/or are augmented with conventional dielectric lenses in simulations run by EM simulator 30B.

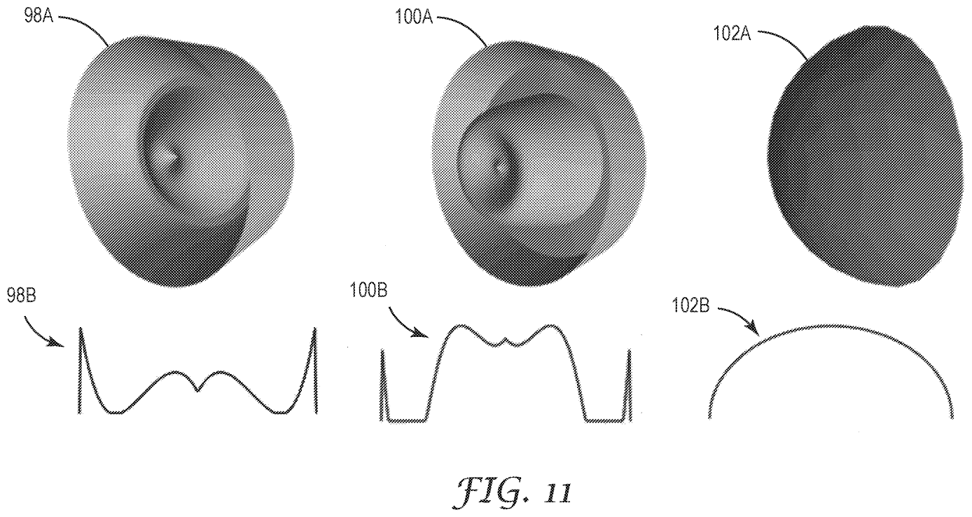

FIG. 11 illustrates aspects of various examples of optimized passive structure designs 34E in comparison to a conventional passive structure design. Dielectric lens designs 98A and 100A illustrate two examples of shapes included in optimized passive structure designs 34E. Cross sections 98A and 100B show cross-sectional views of dielectric lens designs 98A and 100A, respectively. In comparison, conventional lens design 102A and cross section 102B illustrate, respectively, a rendering and a cross-sectional view of the shape of a conventional dielectric lens design. As shown in FIG. 11, conventional lens design 102A and cross section 102B reflect a hemispherical lens design.

A summary of simulation results with respect to the design shown by way of dielectric lens design 98A and cross section 98B (collectively, “automated passive structure design 98”) is described below. The dielectric permittivity modeled for automated passive structure design 98 is 1.49, the loss tangent is 0.0032, the diameter is 64 mm, and the maximum height is 23 mm. These metrics are set to be the same for a comparative experiment conducted using a lens conforming to conventional lens design 102A and cross section 102B (collectively, “hemispherical lens 102). In these simulations, EM simulator 30B was run iteratively with widening scan angles until sidelobes were observed as being larger than the main lobe in plotting beamwidth data points of performance metrics 34B. For a control experiment using a phased antenna array that was not augmented with any dielectric lens, the sidelobe onset was at 36 degrees. For a phased antenna array that was augmented with hemispherical lens 102, the sidelobe onset was at 30 degrees. For a phased antenna array that was augmented with automated passive structure design 98, the sidelobe onset was at 36 degrees. As such, automated passive structure design 98 was shown by EM simulator 30B to provide a significant improvement over hemispherical lens 102 in terms of the onset of sidelobes.

As described above, both the unaugmented phased antenna array and the phased antenna array augmented with automated passive structure design 98 exhibit a sidelobe onset at equal scan angles, thereby providing an equal baseline with respect to certain data points of performance metrics 34B. With respect to peak gain (and as shown in FIG. 10), automated passive structure design 98 provided an improvement over the unaugmented phased antenna array. Moreover, in the simulations run by EM simulator 30B, automated passive structure design 98 was shown to provide a significant beamwidth reduction in comparison to the unaugmented phased antenna array at scan angles that are in the range of 30 degrees to 36 degrees. As such, passive structure design device 20 was shown in experiments to generate optimized passive structure designs in a computing resource-efficient way, while providing particularly advantageous improvements for 5G antenna array augmentation and construction.

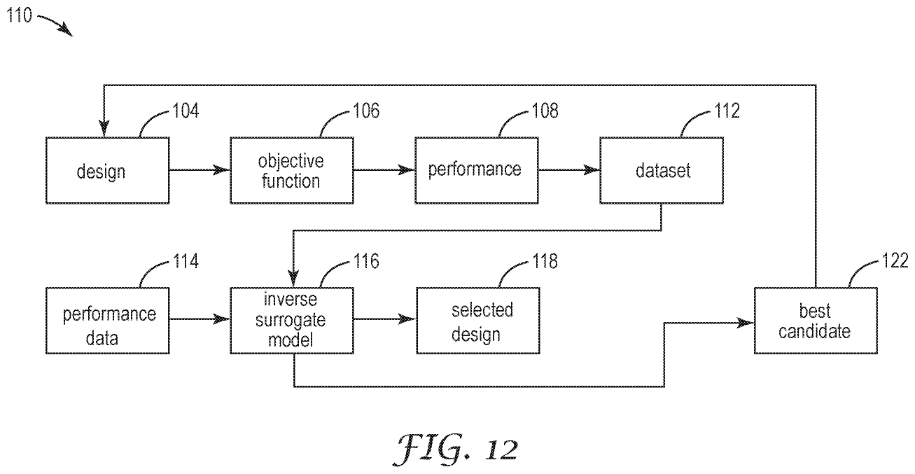

FIG. 12 is a data flow diagram (DFD) 110 that illustrates an example data flow in accordance with the techniques of this disclosure. According to DFD 110, a design 104 (e.g., one of initial passive structure designs 34A) is fed to objective function 106 (which may represent a single execution pass of EM simulator 30B). In turn, EM simulator 30B may populate performance metrics 34B with one or more modeled performance outcomes of design 104. EM simulator 30B may also form dataset 112 using one or more data points of FOM data 34C assigned to design 104 based on dataset 112.

Bayesian optimizer 30C may feed dataset 112 and performance data 114 to inverse surrogate model 116. Performance data 114 may represent intended data points or more desirable data points that can potentially be achieved using one or more of eventual entries in optimized passive structure designs 34E. Using the combination of dataset 112 and performance data 114 as inputs, Bayesian optimizer 30C. In accordance with various aspects of this disclosure, inverse surrogate model 116 may conform to one or more data-driven models in machine learning, deep learning, or reinforcement learning. Example architectures to which inverse surrogate model 116 may conform include, but are not limited to, logistic regression, gaussian processes, random forests, support vector machines, neural networks (e.g., a multilayer perceptron (MLP), a convolutional neural network (CNN), a generative adversarial network (GAN), a variational autoencoder (VAE), etc.), a reinforcement learning model such as a deep Q-network (DQN), or any other model or any combination(s) of such models. Inverse surrogate model 116 may output selected model 118 on a per-iteration basis, and may output best candidate 122 to optimized passive structure designs 34E upon achieving convergence after running a number of iterations.

Bayesian optimizer 30C may be configured to optimize the features of a coplanar waveguide (CPW) that consists of a metal mesh conducting material to maximize electromagnetic transmission through it for 5G frequencies while meeting optical transparency requirements. The techniques implemented by Bayesian optimizer 30C address several technical issues by way of the optimization techniques of this disclosure, such as: the partially or fully concurrent utilization of disparate variable types; assessing the current training status of the surrogate model; finding a global maximum while reducing or eliminating the risk of being stuck around a local maximum; and/or mitigating/eliminating incompleteness and/or an uninformed nature of random sampling. In experiments, an expected improvement cost function (EI (x)) shown in equation (4), a trade-off parameter ξ may be added optionally. Higher values of ξ will cause the acquisition function (shown at 58 of FIG. 4) to weight standard deviation over the improvement, thereby skewing the optimization towards an exlorative mode.

$$EI ( x ) = \{ \begin{matrix}( μ ( x ) - f ( {x}^{+} ) - ξ ) Φ ( Z ) + σ ( x ) ϕ ( Z ) & if σ ( x ) > 0 \\ 0 & if σ ( x ) = 0\end{matrix} , \qquad ( 4 )$$

$$where$$

$$Z = \{ \begin{matrix}\frac{μ ( x ) - f ( {x}^{+} ) - ξ}{σ ( x )} & if σ ( x ) > 0 \\ 0 & if σ ( x ) = 0\end{matrix} .$$

and where
θ(x+)=the best observation;
μ(·)=Gaussian process mean;
σ(·)=Gaussian process standard deviation;
φ(·)=the PDF of the standard normal distribution; and
Φ(·)=CDF of the standard normal distribution.

In some experiments conducted in accordance with the Bayesian optimization techniques of this disclosure, a minimum viable product was defined as the optimization of the grid of the signal and ground planes of a CPW grid in terms of maximizing S11 and S21 values. The parameters of the grid that are identified for optimization are the grid's offset from the edge of the planes, the rotation of the grid about an axis normal to the planes, the shape of the polygons that are tessellated to form the grids, the length of the sides of each polygon, and the width of the wire forming the grid. While the application illustrated in this disclosure is specific to transparent antenna development, it will be appreciated that the optimization 20 techniques described herein can be used in the context of other types of simulation work as well.

With modeling as a service (MaaS) and leveraging data in design becoming more and mor prevalent, computer automated optimization can be widely applied to all types of product development. Some of the experiments in accordance with these techniques utilized a dedicated repository that is specifically designed to be robust and general purpose so that it can be applied to any parameterized optimization problem, which in this case relates to simulations for CPW development as well as dielectric lenses for 5G applications. These methodologies described herein are also well-suited for hyperparameter tuning in ML.

To define and combine variable types, Bayesian optimizer 30C is configured to optimize around qualitative or ‘categorical’ variables as well as quantitative variables. Additionally, Bayesian optimizer 30C may limit certain quantitative variables to discrete values to account for ranges of variables that are not relevant. By classifying our parameters by type, Bayesian optimizer 30C can leverage their classification in order to provide the resource-conserving technical improvements of narrowing the domain, saving time in simulation, and setting up the surrogate model to better handle different types of data. Some of the variable classifications used in experiments run in accordance with this disclosure are described bow. For a “continuous ranged” classification, if a variable is quantitative and falls within a given range, Bayesian optimizer 30C may run process 50 based on the predetermination that process 50 should handle exploring all possibilities between that range.

For a “categorical” classification, if a variable is one of a set number of qualitative labels, Bayesian optimizer 30C may designate such a variable as “categorical.” For a variable that is designated as categorical, Bayesian optimizer 30C may predetermine that the variable can be treated as discrete, and that the variable has no inherent relative arithmetic value. As such, Bayesian optimizer 30C may eliminate any range-based treatment of the categorical variable, and may encode the variable in a way that limits the variable's treatment as a value (such as by using one-hot encoding). Additionally, Bayesian optimizer 30C may use the variable as a classifier to split the domain into smaller sub-domains for better assessment.

For a “discrete” classification, if Bayesian optimizer 30C designates a variable as discrete (e.g. as being one of a predetermined group of possible values), Bayesian optimizer 30C may step through possible values of this variable rather than using resources to analyze a possibly large pool of potential values in a given range. In this scenario, Bayesian optimizer 30C limits the possible solutions based on the “discrete” designation, and as with categorical variables, can leverage the specific value pool to break up the domain into sub-domains for better assessment. For a “combined discrete” classification, Bayesian optimizer 30C may designate variables as being in the “combined discrete” classification if these variables are discrete parameters for which all possible values within a range should be considered as part of optimization according to aspects of process 50. In these scenarios, Bayesian optimizer 30C may identify preferred values of all other parameters that produce the highest values for FoM 34C regardless of what the values of the combined discrete variables are. In this way, Bayesian optimizer 30C may perform an optimization that is robust with respect to parameters that are unknown or are highly variable in real-world applications.

Bayesian optimizer 30C may also implement certain aspects of this disclosure to determine whether the optimization process is stuck in a localized region. In some use case scenarios, optimization processes have the potential to get stuck focusing on local minima within a domain. Techniques of this disclosure enable Bayesian optimizer 30C to provide the technical benefit of assessing which part(s) of the domain are the subject of focus. In accordance with these techniques, Bayesian Optimizer may break the domain up into buckets or sub-domains or ‘domain spaces’ by identifying combinations of categorical and discrete variables. In some examples, Bayesian optimizer 30C may also perform the domain subdivision using quantitative variables by placing values into buckets, which in turn, are defined by different ranges or different sets of ranges. Bayesian Optimizer 30C may use two quantitative variables are used to form axes of a plane within these smaller domain spaces. In turn, Bayesian optimizer 30C may evaluate the concentration of samples within each of these planes. The density of samples in a given that domain space is referred to herein as “localization.” Bayesian optimizer 30C may compare the localization between domain spaces to determine relative concentration(s). Within a given domain space, Bayesian optimizer 30C may construct a polygon or “convex hull” around the samples. Bayesian optimizer 30C may divide the number of samples in each domain space by the area of the convex hull around the samples to determine the localizations of the domain spaces. This calculation is shown by way of equation (5) below:

$$Localization = \frac{Number of Samples}{Area Enclosing Samples} \qquad ( 5 )$$

Bayesian optimizer 30C may use these localization values to push the optimization towards lesser explored domain spaces, such as by improving the acquisition function. For instance, Bayesian optimizer 30C may improve the acquisition function by tying the values to the ξ parameter in the acquisition function. The localization changes for the different domain spaces for the two different optimization processes. Both use random samples for the acquisition function, but the optimization with a ξ value in the acquisition function shows a sharper increase and earlier stabilization of the corresponding values in FoM data 34C in a significantly shorter number runs of EM simulator 30B. The ξ parameter is tied to the localization of the domain of each sample, and the incorporation of the ξ parameter provides benefits associated with exploitative acquisition functions.

In accordance with aspects of this disclosure, Bayesian optimizer 30C may monitor the training of surrogate model 116. As part of the overall optimization, surrogate model 116 undergoes continual training and retraining. To monitor the progress of the training, Bayesian optimizer 30C assesses the extent to which surrogate model 116 is changing between optimization iterations. This technique is described herein is termed as a ‘predictive differences’ method. According to the predictive differences method, Bayesian optimizer 30C may perform the following sequence of operations (iterating and looping as necessary):
1. Generate a set of evenly distributed samples across the domain provided to surrogate model 116.
2. Run surrogate model 116 to make predictions for the samples.
3. At the next iteration of the optimization process, after surrogate model 116 has been updated, once again run surrogate model 116 to make predictions at the same samples used in step 2 above.
4. Evaluate the differences between the predictions made in the current iteration and the predictions made during the preceding iteration.

These differences are expressed as the absolute value of the percent difference between the current predictions and the predictions of the previous iteration. Considering the maximum, average, range, etc. of the prediction differences as they change between iterations can inform Bayesian optimizer 30C regarding the significance of an effect the addition of each known value has on the functioning of surrogate model 116. If Bayesian optimizer 30C determines that none of the prediction differences indicators are changing significantly for a certain (e.g., threshold) number of iterations, then Bayesian optimizer 30C may determine that surrogate model 116 is thoroughly trained for the solution space or is “saturated.” In experiments, periods of significantly higher changes in the predicted values between iterations were observed until about 317 iterations. After reaching 317 iterations, the average of the predicted differences reaches a relatively stable state for the remainder of the optimization iterations. As such, in this particular experiment, 317 iterations denotes a saturation onset of surrogate model 116. Bayesian optimizer 30C may also use predictive differences on a per-domain space basis to monitor how much a given sample affects a specific facet of surrogate model 116 and/or or the progress made in training this particular facet of the surrogate model 116.

Bayesian optimizer 30C may implement certain techniques of this disclosure to optimizing the acquisition function (shown at 58 of FIG. 4). In some examples, Bayesian optimizer 30C may sample in an organized fashion across the domain by utilizing particle swarm optimization (PSO). By implementing PSO, Bayesian optimizer 30C may select random samples that can be treated as “particles,” and then assess the particles' respective positions using the acquisition function. In this way, Bayesian optimizer 30C may determine the best position for each particle (the “best individual particle position”).

In turn, Bayesian optimizer 30C may formulate a vector from the current set of particles' positions to the corresponding set of best individual particle position. For instance, Bayesian optimizer 30C may formulate a vector from the current particle positions to the corresponding single best particle position, and combine the overall set-wide formulation of vectors using vector addition into a single vector. Bayesian optimizer 30C may then apply the vector derived in this way to each particle to move each particle to a new position.

Bayesian optimizer 30C may iterate this process until one or more predetermined criteria are met. This iterative process essentially reflects a sliding progression of the samples across the domain down a gradient defined by the acquisition function. The process covers more of the domain and is a more complete application of the acquisition function to the domain.

As an alternative to PSO, another type of sampling that formed the basis of experimental runs of Bayesian optimizer 30C is referred to “pseudo-continuous” sampling. As used herein, “pseudo-continuous” sampling refers to a sampling mechanism in which step sizes are provided for all quantitative ranged variables. Bayesian optimizer 30C may then sample the domain for all of the values of those variables at these step sizes. In between iterations of the optimization operation, Bayesian optimizer 30C may shift the samples by a random amount in between step sizes to account for potential values between steps. This yields a more defined and detailed precision in sampling, as well as a more uniformly sampled domain. Experiments that were run using pseudo-continuous sampling were shown to generally keep the samples in the same area of the domain in an exploitative fashion. Implementation of pseudo-continuous sampling in conjunction with PSO, ¿ localization may enable Bayesian optimizer 30C to use pseudo-continuous sampling in a more exploratory way to find other maxima throughout the domain, while still providing the benefits of more continuous-type sampling techniques.

As described above, various explorative and exploitative techniques formed the basis of experiments that were run using passive structure generation device 20. A comparison of explorative and exploitative techniques is discussed herein. Bayesian optimizer 30C was run to perform optimizations with the same set of initial samples and ranges but using these different underlying methodologies. FoM data 34C corresponding to a sample evaluated by the objective function each iteration, along with the progression of the maximum FOM was evaluated for three different optimizations. One was a baseline optimization (using neither PSO nor ξ), another used PSO, and a third used tied the ξ value of the acquisition function to the localization of the domain of each sample. The distinguishing features are that the ξ-based optimization seeks to improve the acquisition function, the optimization utilizing PSO seeks to improve the optimization of the acquisition function, and the baseline serves as a control experiment.

The baseline (control experiment) yielded a local maximum comparable to the others upon reaching 365 iterations. The optimization that incorporated plugging the localizations into ξ yielded a similar global maximum in just 151 iterations, while finding numerous local maxima were found along the way. The optimization using PSO achieved a similarly high maximum FoM in just fifteen 15 iterations, but reached a stable state thereupon and did not top the FoM thereafter. While the PSO technique explored the domain more extensively than the other two techniques, it did not enable Bayesian optimizer 30C to find local maxima as high as the other techniques revealed along the way.

In the present detailed description of the example embodiments, reference is made to the accompanying drawings, which illustrate specific embodiments in which the invention may be practiced.

The illustrated embodiments are not intended to be exhaustive of all embodiments according to the invention. It is to be understood that other embodiments may be utilized, and structural or logical changes may be made without departing from the scope of the present invention. The following detailed description, therefore, is not to be taken in a limiting sense, and the scope of the present invention is defined by the appended claims.

Unless otherwise indicated, all numbers expressing feature sizes, amounts, and physical properties used in the specification and claims are to be understood as being modified in all instances by the term “about” or “approximately” or “substantially.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

It is to be recognized that depending on the example, certain acts or events of any of the methods described herein can be performed in a different sequence, may be added, merged, or left out altogether (e.g., not all described acts or events are necessary for the practice of the method). Moreover, in certain examples, acts or events may be performed concurrently, e.g., through multi-threaded processing, interrupt processing, or multiple processors, rather than sequentially.

The techniques described in this disclosure may be implemented, at least in part, in hardware, software, firmware or any combination thereof. For example, various aspects of the described techniques may be implemented within one or more processors, including one or more microprocessors, CPUs, GPUS, DSPs, application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components or integrated within common or separate hardware or software components.

The techniques described in this disclosure may also be embodied or encoded in a computer-readable medium, such as a computer-readable storage medium, containing instructions. Instructions embedded or encoded in a computer-readable storage medium may cause a programmable processor, or other processor, to perform the method, e.g., when the instructions are executed. Computer-readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

Various examples have been described. These and other examples are within the scope of the following claims.

1. A passive structure generation device comprising:
at least one non-transitory computer-readable storage medium having instructions stored thereon;
at least one processor coupled to the at least one non-transitory computer-readable storage medium and configured to execute the instructions to:
receive a passive structure;
generate a figure of merit based on the passive structure and frequency data using a simulation technique;
generate a pool of samples;
select a final sample from the pool of samples using an acquisition function;
provide the final sample to the simulation technique to generate a figure of merit, the final sample being associated with a new passive structure; and
output the new passive structure to at least one of a user interface, an external device, or the at least one non-transitory computer-readable storage medium.

2. The passive structure generation device of claim 1, further comprising generating a pool of samples by executing a scripting agent.

3. The passive structure generation device of claim 2, wherein executing the scripting agent comprises running a script to output one or more variations generated from a conventional passive structure design.

4. The passive structure generation device of claim 3, wherein the conventional passive structure design comprises a hemispherical dielectric lens design.

5. The passive structure generation device of claim 1, wherein using the simulation technique comprises executing an electromagnetic (EM) simulator configured to output one or more performance metrics modeled for an input passive structure design.

6. The passive structure generation device of claim 5, wherein the one or more performance metrics include one or more of a peak gain or a beamwidth.

7. The passive structure generation device of claim 6, wherein the beamwidth is linked to a corresponding scan angle.

8. The passive structure generation device of claim 5, wherein the EM simulator is configured to ingest a single file per execution run to represent a dielectric lens design.

9. The passive structure generation device of claim 1, wherein the acquisition function comprises a probability of improvement function.

10. The passive structure generation device of claim 1, wherein the acquisition function comprises an upper confidence bound (UCB) function.

11. The passive structure generation device of claim 10, wherein the UCB function implements an exploitative function.

12. The passive structure generation device of claim 11, wherein the acquisition function comprises an expected improvement (EI) function.

13. The passive structure generation device of claim 12, wherein the EI function implements an explorative function.

14. The passive structure generation device of claim 13, wherein the EI function comprises a tradeoff parameter associated with a localization value in the domain space.

15. The passive structure generation device of claim 14, wherein the generating the pool of samples comprises:
generating the pool of samples based on the localization value, wherein the pool of samples are generated within a search space in the domain space determined based on the localization value.

16. The passive structure generation device of claim 14, wherein the localization value is indicative of an area enclosing the pool of samples.

17. The passive structure generation device of claim 14, wherein the generating the figure of merit further comprises:
calculating a localization value;
calculating a tradeoff parameter value based on the localization value;
calculating a predicted figure of merit based on the surrogate function;
estimating a predicted uncertainty of the surrogate model; and
generating a ranking of candidate samples based on the predicted figure of merit, the predicted uncertainty of the surrogate model, the localization value, and the tradeoff parameter.

18. The passive structure generation device of claim 17, wherein the acquisition function is configured to calculate the localization value based on an area of a convex hull enclosing the pool of samples and the number of samples enclosed in the convex hull.

19. The passive structure generation device of claim 1, wherein the calculating the new passive structure comprises:
generating a plurality of new passive structures;
training an inverse surrogate model based on the plurality of new passive structures;
providing a set of performance parameter values to the inverse surrogate model; and
receiving the new lens design from the inverse surrogate model.

20. The passive structure generation device of claim 19, wherein the inverse surrogate model comprises at least one of a logistic regression model, a gaussian process model, a random forest model, a support vector machine model, a Deep-Q network, or a neural network that comprises at least one of a multilayer perceptron network (MLP), a convolutional neural network (CNN), a generative adversarial network (GAN), or a variational autoencoder (VAE).

21. (canceled)
